(19) United States
(12) Patent Application Publication
(10) Pub. No.: US 2014/0308840 A1
(43) Pub. Date: Oct. 16, 2014

(54) USB FLASH DRIVE POSITIONING STRUCTURE

(71) Applicant: ADLINK TECHNOLOGY INC., New Taipei City (TW)

(72) Inventor: Jen-Chieh KUO, New Taipei City (TW)

(73) Assignee: ADLINK TECHNOLOGY INC., New Taipei City (TW)

(21) Appl. No.: 13/863,020

(22) Filed: Apr. 15, 2013

(51) Int. Cl. H01R 13/62

(52) U.S. Cl. CPC H01R 13/62
USPC 439/357

(57) ABSTRACT

A USB flash drive positioning structure includes a circuit board carrying an electrical connector that defines therein an insertion slot for receiving a USB flash drive, and a USB flash drive positioning guide including a rectangular cage disposed above the electrical connector, an insertion passage defined in the rectangular cage in communication and alignment with the insertion slot of the electrical connector for the insertion of a USB flash drive into the insertion slot of the electrical connector and curved springy retaining arms suspending inside the rectangular cage around the insertion passage for retaining the inserted USB flash drive in the insertion passage.

### BACKGROUND OF THE INVENTION

1. Field of the Invention

The present invention relates to USB flash drive positioning technology and more particularly, to a USB flash drive positioning structure, which uses a rectangular cage to guide the insertion of a USB flash drive into an electrical connector at a circuit board, and curved springy retaining arms to retaining the inserted USB flash drive in position.

2. Description of the Related Art

Following fast development of computer technology, powerful, high-speed, inexpensive computers and related products with large capacities have been continuously created. Further, many different interface connectors are widely used in computers and related peripheral devices for data transmission. Among the known interface connectors, USB connectors are mostly employed for the advantage of supporting hot plugging.

Further, with the development of information business technology and cloud technology and popularity of social networking sites, personal, home and industrial computers and embedded systems and smart mobile equipment, people can easily find information on the internet. However, when finding data on the internet, the user's personal data can easily be stolen or invaded by a hiker, or computer virus can enter the user's computer system through an attached file of an email. In order to protect user's computer system against hiker or E-mail attached virus, a motherboard or interface circuit board may be equipped with a hardware chip for protecting digital data by means of information encryption and decryption technology. Further, to enhance data security and use convenience, golden key USB flash drives are highly used. By means of plugging or unplugging the golden key, data reading or closing of an encrypted virtual hard disk is automatically performed.

When connecting a USB flash drive to a USB connector at a motherboard or interface circuit board, the user must insert the standard A-plug of the USB flash drive into the insertion slot in the USB connector to force the metal contacts at the tongue plate in the standard A-plug of the USB flash drive into contact with respective metal contacts in the USB connector. After insertion of the standard A-plug of the USB flash drive into the USB connector, spring leaves of the USB connector are respectively engaged into respective locating holes at the standard A-plug of the USB flash drive to hold the inserted USB flash drive in position. However, the limited contact area between the spring leaves of the USB connector and the locating holes at the standard A-plug of the USB flash drive is insufficient to keep the inserted USB flash drive constantly and accurately in position. Further, the motherboard or interface circuit board does not provide any support means around the USB connector to support the inserted USB flash drive in position. If the USB flash drive is vibrated accidentally by an external force, or the user plugs or unplugs an interface card or bus line in the computer system, or the computer system is under an environment of low level of reliability, the inserted USB flash drive may loosened and electrically disconnected from the USB connector.

### SUMMARY OF THE INVENTION

The present invention has been accomplished under the circumstances in view. It is one object of the present invention to provide a USB flash drive positioning structure, which guides the insertion of a USB flash drive into a USB connector at a circuit board and holds the inserted USB flash drive positively in position, avoiding disconnection of the inserted USB flash drive from the USB connector and assuring a high level of reliability.

To achieve this and other objects of the present invention, A USB flash drive positioning structure comprises a circuit board comprising an electrical connector that defines therein an insertion slot for receiving a USB flash drive, and a USB flash drive positioning guide that comprises a rectangular cage disposed above the electrical connector, an insertion passage defined in the rectangular cage in communication and alignment with the insertion slot of the electrical connector for the insertion of a USB flash drive into the insertion slot of the electrical connector, and curved springy retaining arms suspending inside the rectangular cage around the insertion passage for retaining the inserted USB flash drive in the inserted position.

Further, each curved springy retaining arm has its one end connected to the inside wall of the rectangular cage and its other end terminating in a retaining tip for clamping on the periphery of the inserted USB connector. Further, each curved springy retaining arm defines with the inside wall of the rectangular cage a space for the elastic deformation of the respective curved springy retaining arm. Thus, when the user inserts a USB flash drive through the insertion passage in the rectangular cage into the insertion slot in the USB connector, the curved springy retaining arms will be elastically deformed to guide the inserted USB flash drive into the USB connector. After the USB flash drive is inserted into the USB connector, the retaining tips of the curved springy retaining arms are forced by the elastic potential energy of the curved springy retaining arms to clamp down on the periphery of the USB flash drive, holding the USB flash drive positively in position against vibration. Subject to the functioning of the curved springy retaining arms, the USB flash drive positioning guide fits any of a variety of USB flash drives.

In one embodiment of the present invention, the circuit board further comprises a mounting unit arranged around the USB connector. The mounting unit comprises plurality of mounting through holes cut through opposing top and bottom walls of the circuit board, a plurality of female brass pillars each defining therein a screw hole, and a plurality of screws respectively inserted through the mounting through holes at the circuit board and threaded into respective bottom ends of the screw holes of the female brass pillars to affix the female brass pillars to the circuit board. The USB flash drive positioning guide further comprises a plurality of horizontal mounting lugs perpendicularly outwardly extended from the rectangular cage, each horizontal mounting lug defining a respective mounting through hole, and a plurality of screws respectively inserted through the mounting through holes at the horizontal mounting lugs and threaded into respective top ends of the screw holes of the female brass pillars to affix the rectangular cage to the female brass pillars above the USB connector.

In another embodiment of the present invention, the USB flash drive positioning structure further comprises a bracket adapted to support the circuit board. The bracket comprises an opening adapted to receive the electrical connector of the circuit board, and a plurality of mounting screw holes spaced around the opening. Further, the horizontal mounting lugs of the USB flash drive positioning guide are respectively affixed to the mounting through holes of the bracket by a respective screw, holding the rectangular cage in the top side of the opening of the bracket in axial alignment with the USB connector.

### BRIEF DESCRIPTION OF THE DRAWINGS

FIG. 1 is an oblique top elevation of a USB flash drive positioning structure in accordance with a first embodiment of the present invention.

FIG. 2 is an exploded view, in an enlarged scale, of the USB flash drive positioning guide used in the USB flash drive positioning structure in accordance with the first embodiment of the present invention.

FIG. 3 is an exploded view of the USB flash drive positioning structure in accordance with the first embodiment of the present invention.

FIG. 4 corresponds to FIG. 3, illustrating the female brass spacer pillars affixed to the circuit board.

FIG. 5 is a schematic sectional assembly view, in an enlarged scale, of the USB flash drive positioning structure in accordance with the first embodiment of the present invention.

FIG. 6 is a schematic applied view of the present invention, illustrating installation of a USB flash drive in the USB flash drive positioning structure in accordance with the first embodiment of the present invention (I).

FIG. 7 is a schematic applied view of the present invention, illustrating installation of a USB flash drive in the USB flash drive positioning structure in accordance with the first embodiment of the present invention (I).

FIG. 8 is a schematic sectional applied view of a USB flash drive positioning structure in accordance with a second embodiment of the present invention.

### DETAILED DESCRIPTION OF THE PREFERRED EMBODIMENT

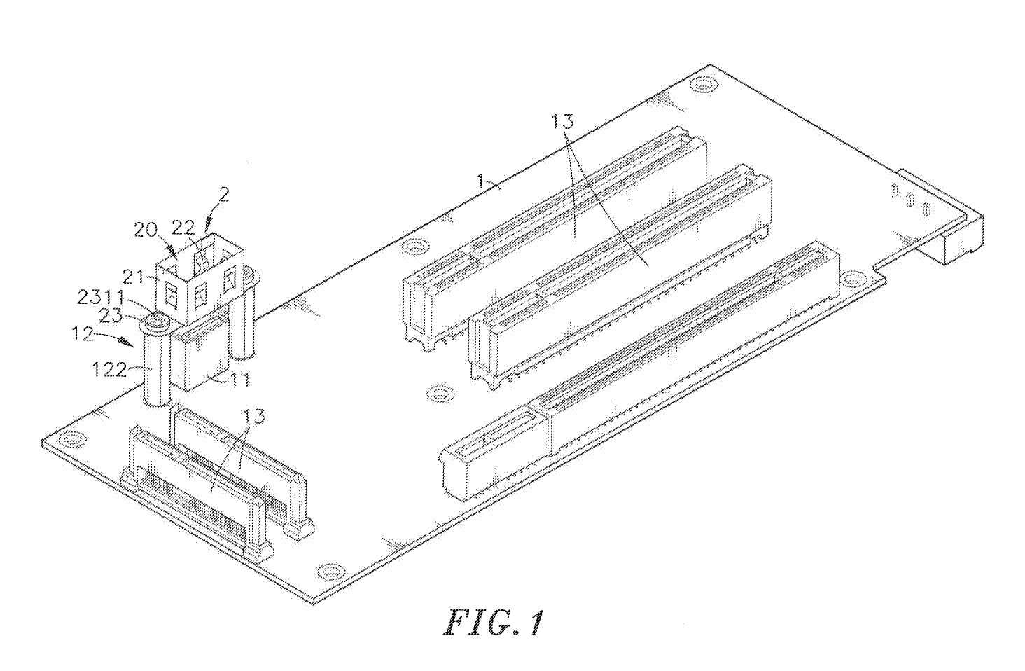

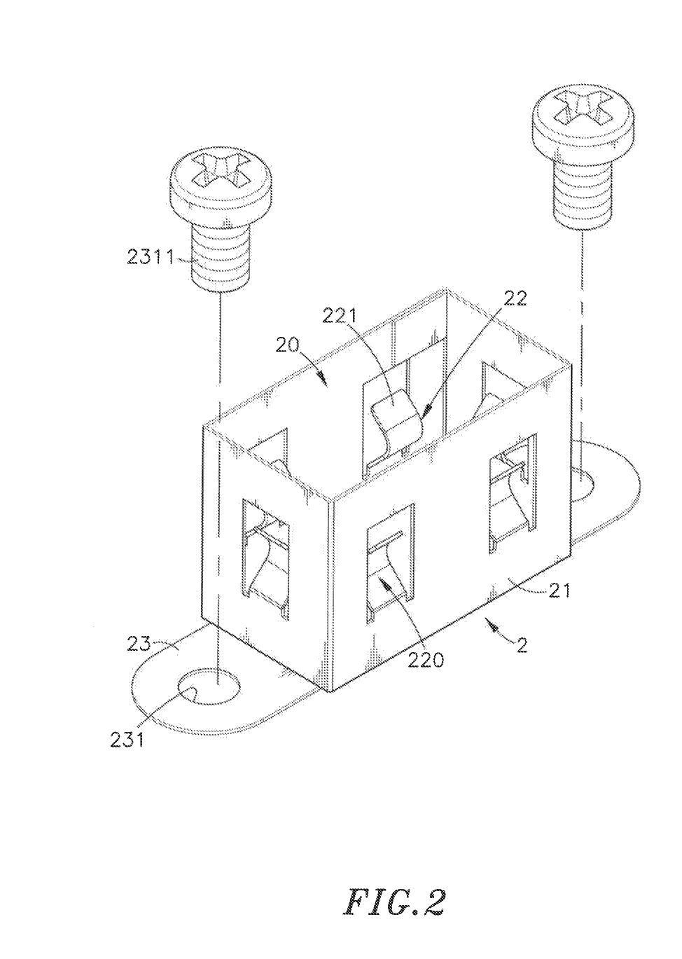

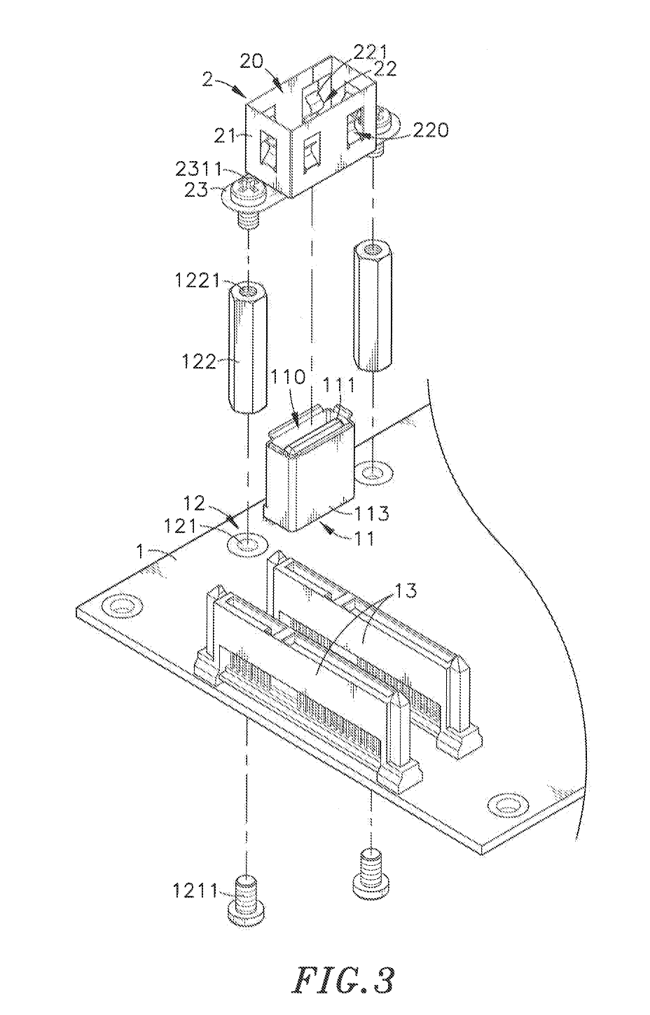

Referring to FIGS. 1-3, a USB flash drive positioning structure in accordance with a first embodiment of the present invention is shown comprising a circuit board 1, and a USB flash drive positioning guide 2.

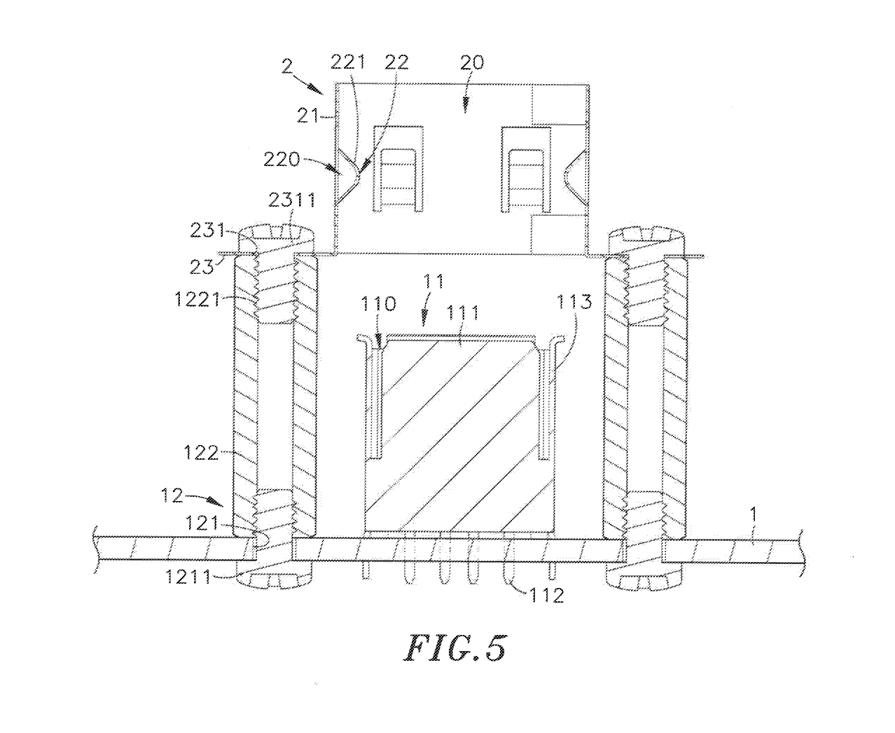

The circuit board 1 comprises an electrical connector 11, and a mounting unit 12 arranged around the electrical connector 11. In this embodiment, the electrical connector 11 is a USB female connector comprising a connector body 111, a set of metal contacts 112 positioned in a tongue plate of the connector body 111 (see FIG. 5), a connector housing 113 surrounding the connector body 111, and an insertion slot 110 defined in between the connector housing 113 and the tongue plate of the connector body 111. The mounting unit 12 comprises a plurality of, for example, two mounting through holes 121 cut through opposing top and bottom walls of the circuit board 1 and symmetrically disposed at two opposite lateral sides relative to the electrical connector 11, two female brass pillars 122 each defining therein a screw hole 1221, and two screws 1211 respectively inserted through the mounting through holes 121 and threaded into respective bottom ends of the screw holes 1221 of the female brass pillars 122 to affix the female brass pillars 122 to the mounting through holes 121 of the circuit board 1.

Further, the circuit board 1 can be a motherboard or interface circuit board, carrying on one or each of the two opposing top and bottom walls thereof a control chip (not shown) and a plurality of connection modules 13 configured subject to SATA, ISA, PCI, PCI-X or PCI-E standard. Further, the circuit board 1 provides a plug member (not shown) configured subject to ISA, PCI, PCI-X or PCI-E standard and located at one lateral side thereof. It is to be noted that different circuit boards from different providers have different design specifications. Since the detailed circuit board structural composition is not within the scope of the present invention, no further detailed description in this regard shall be necessary.

The USB flash drive positioning guide 2 comprises a rectangular cage 21 supported on the female brass pillars 122 of the mounting unit 12 at the circuit board 1 above the electrical connector 11, an insertion passage 20 defined in the rectangular cage 21 in communication with the insertion slot 110 of the electrical connector 11, a plurality of curved springy retaining arms 22 formed integrally with the inside wall of the rectangular cage 21 around the insertion passage 20 and respectively terminating in a retaining tip 221 and respectively defining with the inside wall of the rectangular cage 21 a space 220 for the elastic deformation of the respective curved springy retaining arm 22, two horizontal mounting lugs 23 respectively and perpendicularly extended from two opposite lateral sides of the rectangular cage 21 and defining therein a respective mounting through hole 231, and two screws 2311 respectively inserted through the mounting through holes 231 of the horizontal mounting lugs 23 and threaded into respective top ends of the screw holes 1221 of the female brass pillars 122 to affix the rectangular cage 21 to the female brass pillars 122 above the electrical connector 11.

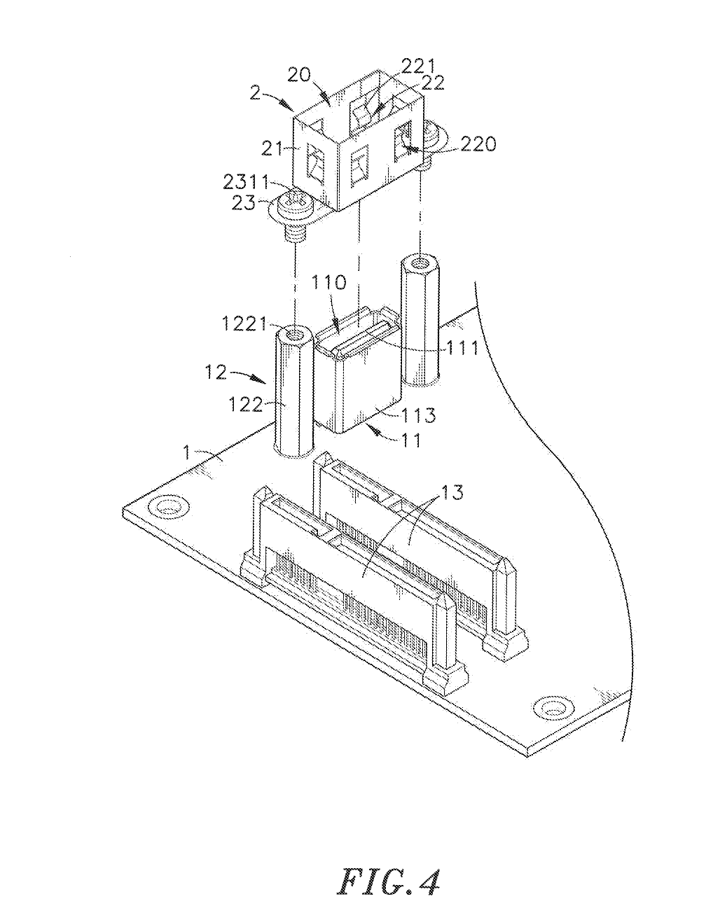

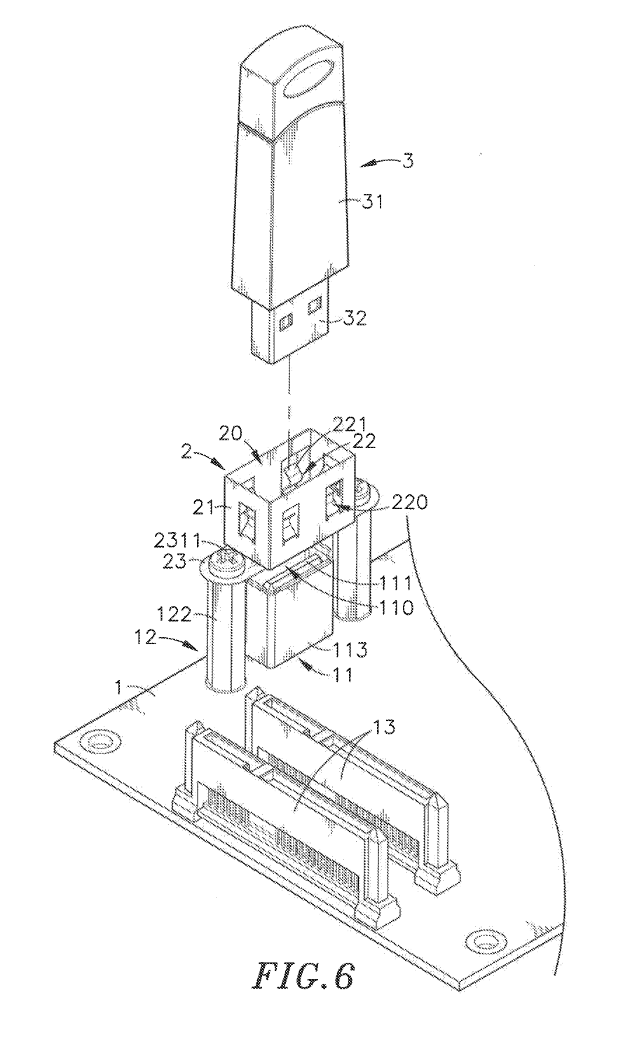

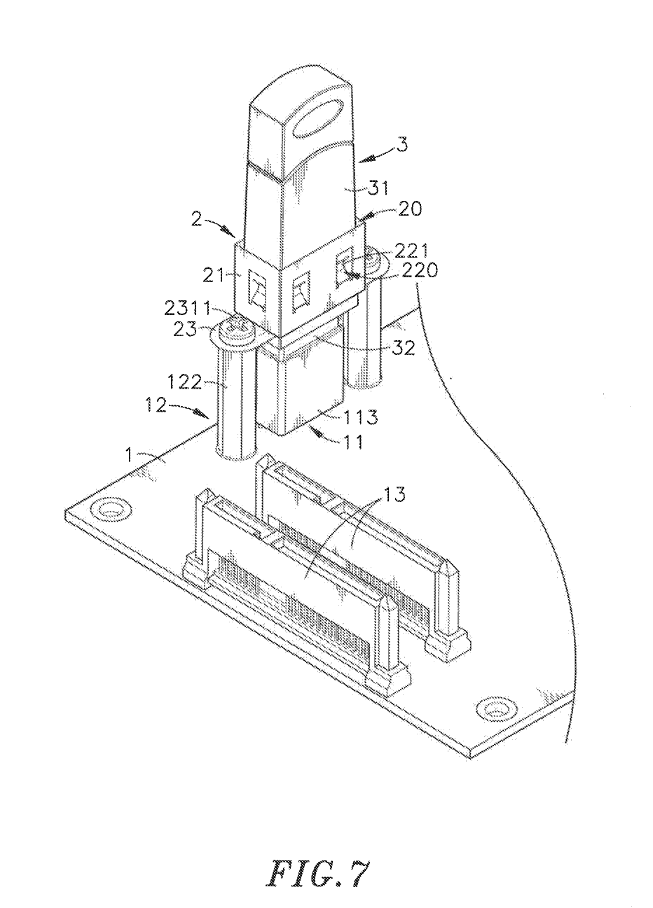

Referring to FIGS. 4-7, during installation of the USB flash drive positioning structure, attach the two horizontal mounting lugs 23 of the USB flash drive positioning guide 2 to the topmost edges of the female brass pillars 122 at the circuit board 1 respectively, and then insert the respective screws 2311 through the mounting through holes 231 of the horizontal mounting lugs 23 and thread the respective screws 2311 into the respective top ends of the screw holes 1221 of the female brass pillars 122 to affix the rectangular cage 21 to the female brass pillars 122 above the electrical connector 11, keeping the insertion passage 20 in the rectangular cage 21 in communication and alignment with the insertion slot 110 of the electrical connector 11. After installation, the rectangular cage 21 is supported on the female brass pillars 122 and spaced above the electrical connector 11 at a predetermined distance.

When connecting a USB flash drive 3 to the electrical connector 11 at the circuit board 1, downwardly insert the front end of the standard A-plug 32 of the USB flash drive 3 into the insertion passage 20 in the rectangular cage 21 toward the insertion slot 110 of the electrical connector 11 to force the outer plastic shell 31 of the USB flash drive 3 against the curved springy retaining arms 22, elastically deforming the curved springy retaining arms 22. After insertion of the standard A-plug 32 of the USB flash drive 3 into the insertion slot 110 of the electrical connector 11, the internal metal contacts (not shown) in the standard A-plug 32 of the USB flash drive 3 are respectively electrically kept in contact with the metal contacts 112 in the tongue plate of the connector body 111 of the electrical connector 11, and the retaining tips 221 of the respective curved springy retaining arms 22 are clamped on the periphery of the outer plastic shell 31 of the USB flash drive 3, holding the USB flash drive 3 positively in position against vibration.

Further, during downward insertion of the USB flash drive 3, the curved springy retaining arms 22 will be forced by the outer plastic shell 31 of the USB flash drive 3 to curve outward, allowing the standard A-plug 32 of the USB flash drive 3 to pass through the insertion passage 20 into the insertion slot 110 of the electrical connector 11 After the standard A-plug 32 of the USB flash drive 3 is inserted into the insertion slot no of the electrical connector 11, the retaining tips 221 of the curved springy retaining arm 22 are forced by the elastic potential energy of the curved springy retaining arm 22 to clamp the periphery of the outer plastic shell 31 of the USB flash drive 3, holding the USB flash drive 3 positively in position against vibration. Subject to the functioning of the curved springy retaining arms 22, the USB flash drive positioning guide 2 fits any of a variety of USB flash drives.

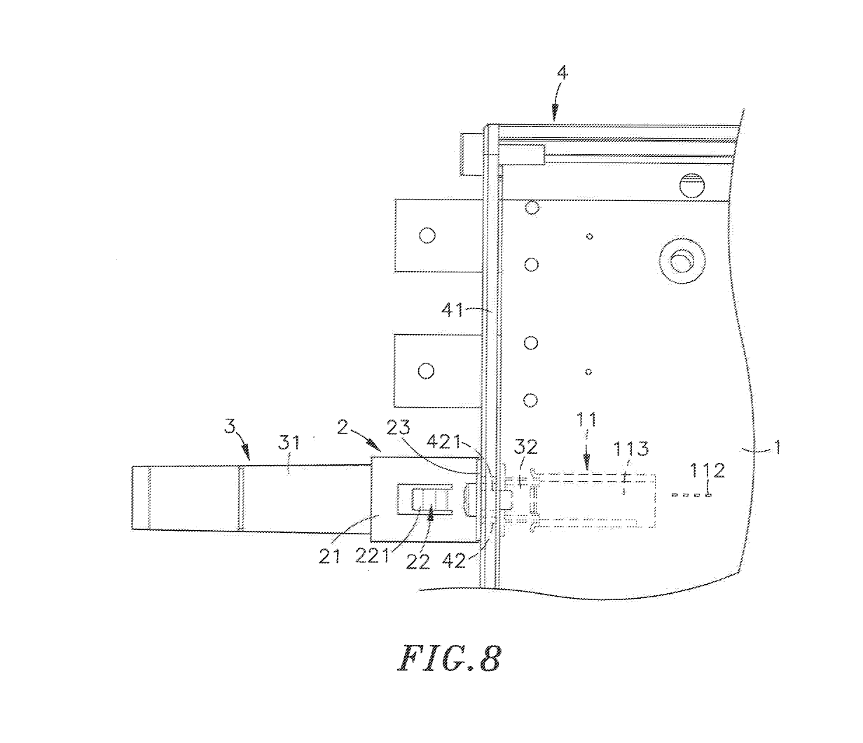

Referring to FIG. 8, a USB flash drive positioning structure in accordance with a second embodiment of the present invention is shown. According to this second embodiment, the USB flash drive positioning structure comprises a bracket 41 defining an opening 42 and two mounting screw holes 421 at two opposite lateral sides relative to the opening 42, a circuit board 1 fixedly mounted in the bracket 41 and carrying an electrical connector 11 in the opening 42, and a USB flash drive positioning structure 2 supported on the bracket 41. The USB flash drive positioning guide 2 in accordance with this second embodiment is identical to the USB flash drive positioning guide of the aforesaid first embodiment.

During installation of this second embodiment of USB flash drive positioning structure, attach the two horizontal mounting lugs 23 of the USB flash drive positioning structure 2 to the bracket 41 to keep the mounting through holes 231 of the two horizontal mounting lugs 23 in alignment with the respective mounting screw holes 421 of the bracket 41, and then insert the respective screws 2311 through the mounting through holes 231 of the horizontal mounting lugs 23 of the USB flash drive positioning structure 2 and thread the screws 2311 into the respective mounting screw holes 421 of the bracket 41 to affix the rectangular cage 21 to the bracket 41 above the electrical connector 11 of the circuit board 1, keeping the insertion passage 20 (not shown) in the rectangular cage 21 in communication and alignment with the insertion slot 110 of the electrical connector 11. This alternate form eliminates the aforesaid female brass spacer pillars, lowering the installation time and cost.

When connecting a USB flash drive 3 to the electrical connector 11 at the circuit board 1, insert the front end of the standard A-plug 32 of the USB flash drive 3 into the insertion passage 20 in the rectangular cage 21 of the USB flash drive positioning structure 2 toward the insertion slot 110 of the electrical connector 11 to force the outer plastic shell 31 of the USB flash drive 3 against the curved springy retaining arms 22 elastically deforming the curved springy retaining arms 22. After insertion of the standard A-plug 32 of the USB flash drive 3 into the insertion slot 110 of the electrical connector 11, the internal metal contacts (not shown) in the standard A-plug 32 of the USB flash drive 3 are respectively electrically kept in contact with the metal contacts 112 in the the electrical connector 11, and the retaining tips 221 of the respective curved springy retaining arms 22 are clamped on the periphery of the outer plastic shell 31 of the USB flash drive 3, holding the USB flash drive 3 positively in position against vibration.

In conclusion, the invention provides a USB flash drive positioning structure, which comprises a circuit board 1 carrying an electrical connector 11 for the connection of a USB flash drive 3, and a USB flash drive positioning guide 2 kept in proximity to the electrical connector 11 for guiding insertion of a USB flash drive 3 into the electrical connector 11 and securing the inserted USB flash drive 3 in place by curved springy retaining arms 22 thereof. The structural design of the USB flash drive positioning guide 2 fits any of a variety of USB flash drives, and enhances the electrical connection between the electrical connector 11 of the circuit board 1 and the inserted USB flash drive.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A USB flash drive positioning structure, comprising:
a circuit board comprising an electrical connector, said electrical connector defining therein an insertion slot for receiving a USB flash drive; and
a USB flash drive positioning guide comprising a rectangular cage disposed above said electrical connector, an insertion passage defined in said rectangular cage in communication and alignment with said insertion slot of said electrical connector for the insertion of a USB flash drive into said insertion slot of said electrical connector, and at least one curved springy retaining arm suspending inside said rectangular cage around said insertion passage for retaining the inserted USB flash drive in said insertion passage.

2. The USB flash drive positioning structure as claimed in claim 1, wherein said electrical connector of said circuit board is a USB female connector comprising a connector body, a set of metal contacts positioned in a tongue plate of said connector body, and a connector housing surrounding said connector body; said insertion slot is defined in between said connector housing and said tongue plate of said connector body.

3. The USB flash drive positioning structure as claimed in claim 1, wherein said circuit board further comprises a mounting unit arranged around said electrical connector, said mounting unit comprising plurality of mounting through holes cut through opposing top and bottom walls of said circuit board, a plurality of female brass pillars, each said female brass pillar defining therein a screw hole, and a plurality of screws respectively inserted through the mounting through holes at said circuit board and threaded into respective bottom ends of the screw holes of said female brass pillars to affix said female brass pillars to said circuit board; said USB flash drive positioning guide further comprises a plurality of horizontal mounting lugs respectively and perpendicularly extended from said rectangular cage, each said horizontal mounting lug defining a respective mounting through hole, and a plurality of screws respectively inserted through the mounting through holes at said horizontal mounting lugs and threaded into respective top ends of the screw holes of said female brass pillars to affix said rectangular cage to said female brass pillars.

4. The USB flash drive positioning structure as claimed in claim 1, further comprising a bracket adapted to support said circuit board, said bracket comprising an opening adapted to receive said electrical connector of said circuit board and a plurality of mounting screw holes spaced around said opening, wherein said USB flash drive positioning guide further comprises a plurality of horizontal mounting lugs respectively and perpendicularly extended from said rectangular cage and respectively affixed to said mounting through holes of said bracket by a respective screw.

5. The USB flash drive positioning structure as claimed in claim 1, wherein each said curved springy retaining arm has one end thereof connected to an inside wall of said rectangular cage and an opposite end thereof terminating in a retaining tip for clamping on the periphery of the inserted USB connector, each said cured springy retaining arm defining with an inside wail of said rectangular cage a space for the elastic deformation of the respective curved springy retaining arm.

6. A USB flash drive positioning structure, comprising a USB flash drive positioning guide, said USB flash drive positioning guide comprising a rectangular cage, an insertion passage defined in said rectangular cage for the insertion of a USB flash drive, and at least one curved springy retaining arm suspending inside said rectangular cage around said insertion passage for retaining the inserted USB flash drive in said insertion passage.

7. The USB flash drive positioning structure as claimed in claim 6, wherein each said curved springy retaining arm has one end thereof connected to an inside wall of said rectangular cage and an opposite end thereof terminating in a retaining tip for clamping on the periphery of the inserted USB connector.

8. The USB flash drive positioning structure as claimed in cairn 7, wherein each said curved springy retaining arm defines with an inside wall of said rectangular cage a space for the elastic deformation of the respective curved springy retaining arm.
